(19) United States
(12) Patent Application Publication
(10) Pub. No.: US 2023/0114013 A1
(43) Pub. Date: Apr. 13, 2023

(54) ENHANCED MACHINE LEARNING PIPELINES WITH MULTIPLE OBJECTIVES AND TRADEOFFS

(71) Applicant: INTERNATIONAL BUSINESS MACHINES CORPORATION, Armonk, NY (US)

(72) Inventors: Radu MARINESCU, Dublin (IE); Parikshit RAM, Atlanta, GA (US)

(73) Assignee: INTERNATIONAL BUSINESS MACHINES CORPORATION, Armonk, NY (US)

(21) Appl. No.: 17/450,670

(22) Filed: Oct. 12, 2021

(51) Int. Cl. G06N 20/00

(52) U.S. Cl. CPC G06N 20/00

(57) ABSTRACT

Tradeoffs, objectives, and one or more machine learning models are analyzed. One or more instantiated machine learning pipelines are generated based on the tradeoffs and objectives. A first instantiated machine learning pipeline is preferred compared to a second instantiated machine learning pipeline based on the plurality of tradeoffs and objectives.

### BACKGROUND

The present invention relates in general to computing systems, and more particularly, to various embodiments for providing enhanced machine learning pipelines with multiple objectives and tradeoffs using a computing processor.

### SUMMARY

According to an embodiment of the present invention, a method for enhanced machine learning pipelines with multiple objectives and tradeoffs in a computing environment, by one or more processors, in a computing system. Tradeoffs, objectives, and one or more machine learning models are analyzed. One or more instantiated machine learning pipelines are generated based on the tradeoffs and objectives. A first instantiated machine learning pipeline is preferred compared to a second instantiated machine learning pipeline based on the plurality of tradeoffs and objectives.

An embodiment includes a computer usable program product. The computer usable program product includes a computer-readable storage device, and program instructions stored on the storage device.

An embodiment includes a computer system. The computer system includes a processor, a computer-readable memory, and a computer-readable storage device, and program instructions stored on the storage device for execution by the processor via the memory.

Thus, in addition to the foregoing exemplary method embodiments, other exemplary system and computer product embodiments are provided.

### BRIEF DESCRIPTION OF THE DRAWINGS

FIG. 1 is a block diagram depicting an exemplary cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 is an additional block diagram depicting an exemplary functional relationship between various aspects of the present invention.

FIG. 5 depicts a block flow diagram for providing enhanced machine learning pipelines with multiple objectives and tradeoffs in a computing environment according to an embodiment of the present invention.

FIG. 6 is a flowchart diagram depicting an additional exemplary method for providing enhanced machine learning pipelines with multiple objectives and tradeoffs in a computing environment, by a processor, in which aspects of the present invention may be realized.

### DETAILED DESCRIPTION OF THE DRAWINGS

The present invention relates generally to the field of artificial intelligence (“AI”) such as, for example, machine learning and/or deep learning. Machine learning allows for an automated processing system (a “machine”), such as a computer system or specialized processing circuit, to develop generalizations about particular datasets and use the generalizations to solve associated problems by, for example, classifying new data. Once a machine learns generalizations from (or is trained using) known properties from the input or training data, it can apply the generalizations to future data to predict unknown properties.

Moreover, machine learning is a form of AI that enables a system to learn from data rather than through explicit programming. A major focus of machine learning research is to automatically learn to recognize complex patterns and make intelligent decisions based on data, and more efficiently train machine learning models and pipelines. However, machine learning is not a simple process. As the algorithms ingest training data, it is then possible to produce more precise models based on that data. A machine-learning model is the output generated when a machine-learning algorithm is trained with data. After training, input is provided to the machine learning model which then generates an output. For example, a predictive algorithm may create a predictive model. Then, the predictive model is provided with data and a prediction is then generated (e.g., “output”) based on the data that trained the model.

Machine learning enables machine learning models to train on datasets before being deployed. Some machine-learning models are online and continuous. This iterative process of online models leads to an improvement in the types of associations made between data elements. Different conventional techniques exist to create machine learning models and neural network models. The basic prerequisites across existing approaches include having a dataset, as well as basic knowledge of machine learning model synthesis, neural network architecture synthesis and coding skills.

In one aspect, automated AI machine learning (“ML”) systems (“AutoAI systems” or automated machine learning systems “auto ML system”) may generate multiple (e.g., hundreds) machine learning pipelines. Designing a machine learning pipeline involves several decisions such as, for example, which data preparation and preprocessing operations should be applied, which machine algorithm should be used with which settings (hyperparameters). AI machine learning systems may automatically search for an approved or satisfactorily performing pipeline.

For example, creating a machine learning pipeline for a given dataset involves a sequence of operations/steps that are repeated (semi-automated process) in a trial-and-error manner until the desired performance is achieved. A current challenge exists in attempting to automate the machine learning pipeline process. However, being able to considers multiple objectives at a time (e.g., classification accuracy) while using more than pareto-optimal pipelines for multi-criteria automated machine learning is a major challenge.

Thus, as described herein, the present disclosure provides a novel approach for providing enhanced machine learning pipelines with multiple objectives and tradeoffs in a computing environment, by one or more processors, in a computing system. Tradeoffs, objectives, and one or more machine learning models are analyzed. One or more instantiated machine learning pipelines are generated based on the tradeoffs and objectives. A first instantiated machine learning pipeline is preferred compared to a second instantiated machine learning pipeline based on the plurality of tradeoffs and objectives.

In some implementations, the present disclosure extends automated machine learning to generate machine learning pipelines that simultaneously optimize multiple objectives, which may be objectives that conflict with each other, such as, for example, machine learning model accuracy, precision, recall, and/or an F1score (e.g., a function of precision and recall) all at the same time). In one aspect, the F1 score is used to apply balance between precision and recall. Thus, by optimizing multiple objectives at the same time, one or more optimized machine learning pipelines may be generated very relevant to the data scientist as it provides more flexibility in choosing the right pipeline that meets the required tradeoffs in terms of objectives

In some implementations, one or more machine learning model objectives/preferences (e.g., accuracy, precision, recall, an F1score, inferences, time, etc.) are encoded by an unknow weighting function that weights each objective (e.g., a machine learning model or user is not committed to a particular weighting of the objectives). In some implementations, one or more optimal pipelines (“PO”) may be generated rather than Pareto-optimal pipelines (the latter is a much larger set than the former). A PO pipeline is optimal machine learning pipeline is a machine learning pipeline having particular weighting of the objectives. That is, the optimal machine learning pipeline is a machine learning pipeline that simultaneously optimizes multiple objectives while applying one or more tradeoffs. As used herein, “PO” represents a “possibly optimal” pipeline, where pipeline means a machine learning pipeline. By definition, a pipeline is “possibly optimal” (ie., a PO pipeline) if there exists a weighting of the objectives for which that pipeline is optimal (namely there's no other pipeline more efficient or “better” than the PO pipeline). If the weighing of the objectives is available (or known), then the multi-objective optimization problem translates into a single objective optimization problem. As used herein, the present disclosure assumes that the weighting of the objectives is unknown.

In some implementations, one or more specific, imprecise tradeoffs between the objectives may be provided, suggested, or learned (e.g., trade 1 unit of accuracy for 2 units of recall), without having to rescale/normalize the scales of the objectives. Thus, the present invention provides for generating one or more optimal pipelines with respect to multiple objective that are simultaneously optimized.

In an additional aspect, as used herein, a machine learning pipeline may be one or more processes, operations, or steps to train a machine learning process or model (e.g., creating computing application code, performing various data operations, creating one or more machine learning models, adjusting and/or tuning a machine learning model or operation, and/or various defined continuous operations involving machine learning operations). In addition, a machine learning pipeline may be one or more machine learning workflows that may enable a sequence of data to be transformed and correlated together in a machine learning model that may be tested and evaluated to achieve an outcome. Additionally, a trained machine learning pipeline may include an arbitrary combination of different data curation and preprocessing steps. The machine learning pipeline may include at least one machine learning model. Also, a trained machine learning pipeline may include at least one trained machine learning model.

In one aspect, a machine learning model may be a system that takes as input the curated and preprocessed data and will output a prediction (e.g., the output of all steps that happened before in the machine learning pipeline), depending on the task, and the prediction may be a forecast, a class, and/or a more complex output such as, for example, sentences in case of translation. In another aspect, a machine-learning model is the output generated upon training a machine-learning algorithm with data. After training, the machine learning model may be provided with an input and the machine learning model will provide an output.

In general, as used herein, “optimize” may refer to and/or defined as “maximize,” “minimize,” or attain one or more specific targets, objectives, goals, or intentions. Optimize may also refer to maximizing a benefit to a user (e.g., maximize a trained machine learning pipeline/model benefit). Optimize may also refer to making the most effective or functional use of a situation, opportunity, or resource.

Additionally, optimizing need not refer to a best solution or result but may refer to a solution or result that “is good enough” for a particular application, for example. In some implementations, an objective is to suggest a “best” combination of preprocessing operations (“preprocessors”) and/or machine learning models/machine learning pipelines, but there may be a variety of factors that may result in alternate suggestion of a combination of preprocessing operations (“preprocessors”) and/or machine learning models yielding better results. Herein, the term “optimize” may refer to such results based on minima (or maxima, depending on what parameters are considered in the optimization problem). In an additional aspect, the terms “optimize” and/or “optimizing” may refer to an operation performed in order to achieve an improved result such as reduced execution costs or increased resource utilization, whether or not the optimum result is actually achieved. Similarly, the term “optimize” may refer to a component for performing such an improvement operation, and the term “optimized” may be used to describe the result of such an improvement operation.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

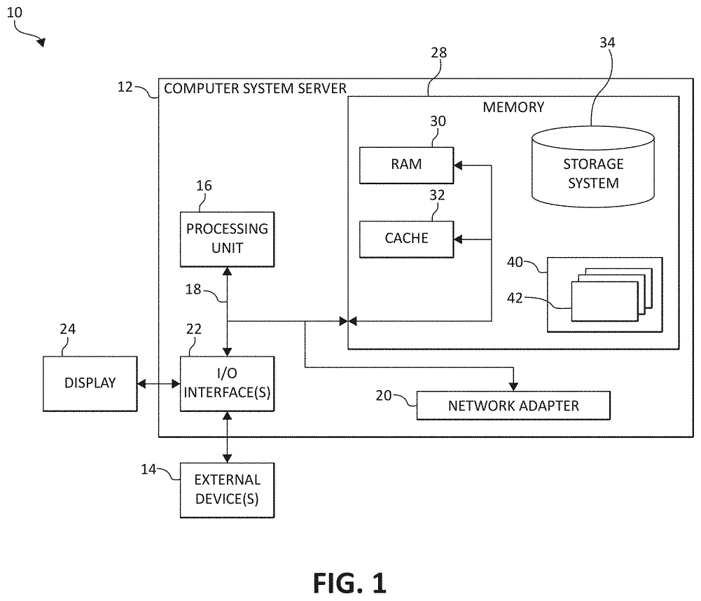

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

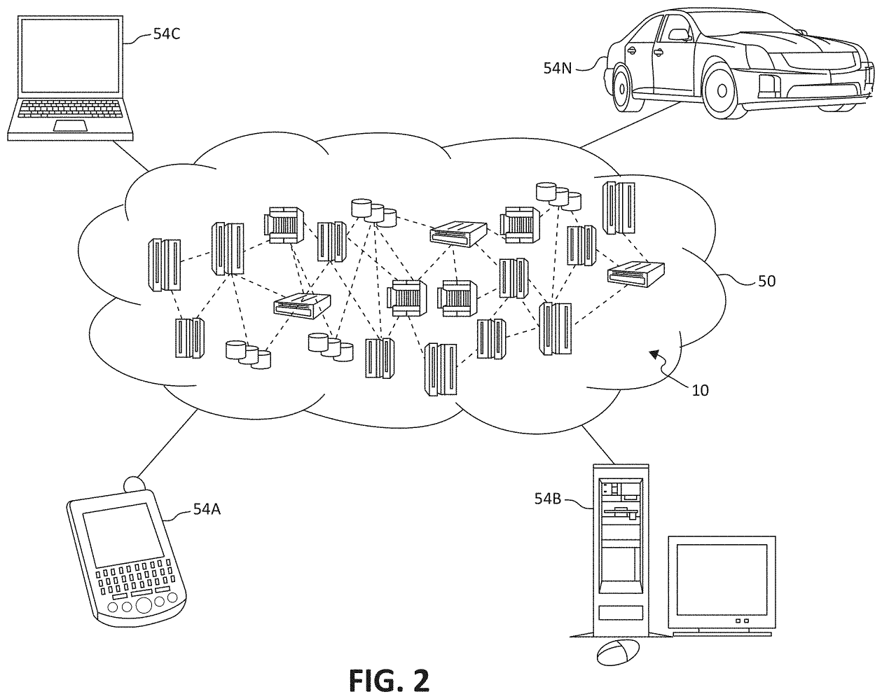

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

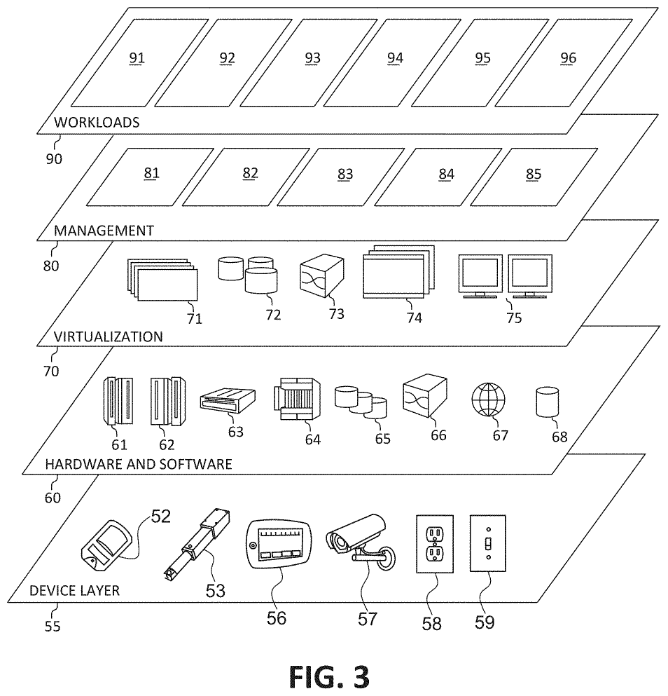

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote-control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for providing enhanced machine learning pipelines with multiple objectives and tradeoffs in a computing environment (e.g., in a neural network architecture). In addition, workloads and functions 96 for providing enhanced machine learning pipelines with multiple objectives and tradeoffs in a computing environment may include such operations as analytics, deep learning, and as will be further described, user and device management functions. One of ordinary skill in the art will appreciate that the workloads and functions 96 for providing enhanced machine learning pipelines with multiple objectives and tradeoffs in a computing environment may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

As previously stated, the present invention provides novel solutions for providing enhanced machine learning pipelines with multiple objectives and tradeoffs in a computing environment by one or more processors in a computing system. Tradeoffs, objectives, and one or more machine learning models are analyzed. One or more instantiated machine learning pipelines are generated based on the tradeoffs and objectives. A first instantiated machine learning pipeline is preferred compared to a second instantiated machine learning pipeline based on the plurality of tradeoffs and objectives.

Thus, in some implementations, the present invention provides novel solutions for automating the machine learning pipeline construction process by optimizing multiple objectives simultaneously. One or more imprecise tradeoffs between the objectives may be considered and applied for automating the machine learning pipeline construction without having to alter the scales or degree of importance/priority of the objectives, which results in a set of optimized machine learning pipelines. This set of optimized machine learning pipelines can be significantly smaller than the Pareto-optimal machine learning pipelines.

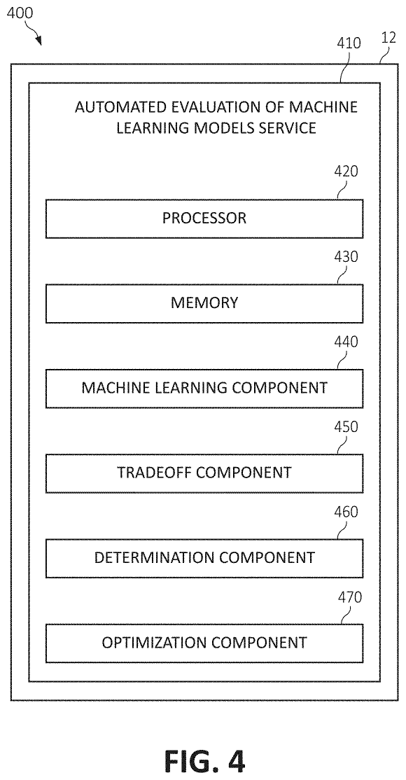

Turning now to FIG. 4, a block diagram depicting exemplary functional components of system 400 for ranking time series forecasting machine learning pipelines in a computing environment (e.g., in a neural network architecture) according to various mechanisms of the illustrated embodiments is shown. In one aspect, one or more of the components, modules, services, applications, and/or functions described in FIGS. 1-3 may be used in FIG. 4. As will be seen, many of the functional blocks may also be considered “modules” or “components” of functionality, in the same descriptive sense as has been previously described in FIGS. 1-3.

An automated evaluation of machine learning models service 410 is shown, incorporating processing unit 420 (“processor”) to perform various computational, data processing and other functionality in accordance with various aspects of the present invention. In one aspect, the processor 420 and memory 430 may be internal and/or external to the automated evaluation of machine learning models service 410, and internal and/or external to the computing system/server 12. The automated evaluation of machine learning models service 410 may be included and/or external to the computer system/server 12, as described in FIG. 1. The processing unit 420 may be in communication with the memory 430. The automated evaluation of machine learning models service 410 may include a machine learning component 440, a tradeoff component 450, a determination component 460, and an optimization component 470.

In one aspect, the system 400 may provide virtualized computing services (i.e., virtualized computing, virtualized storage, virtualized networking, etc.). More specifically, the system 400 may provide virtualized computing, virtualized storage, virtualized networking and other virtualized services that are executing on a hardware substrate.

The machine learning component 440, in association with the machine learning component 440, the tradeoff component 450, the determination component 460, and the optimization component 470 may analyze a plurality of tradeoffs and objectives and one or more machine learning models, and generate one or more instantiated machine learning pipelines based on the plurality of tradeoffs and objectives

In one aspect, the machine learning component 440 may receive, identify, and/or select a machine learning model and/or machine learning pipeline, a dataset for a data set used for testing the machine learning model and/or machine learning pipeline.

The machine learning component 440, in association with the tradeoff component 450, the determination component 460, and the optimization component 470 may generate a plurality of additional tradeoffs in relation to the objectives.

The machine learning component 440, in association with the machine learning component 440, the tradeoff component 450, the determination component 460, and the optimization component 470 may define the objectives, the plurality of tradeoffs, and the one or more machine learning models, where an objective includes one or more performance objectives of the one or more machine learning models and a tradeoff includes one or more objectives that are replaced with one or more alternative objectives.

The tradeoff component 450 may require a pair of vectors having a first vector representing a first objective and a second vector representing a second objective, where the first objective is a preferred objective compared to the second objective.

The tradeoff component 450 may assign weighted values to each of the objectives. The tradeoff component 450 may switch one or more of the objectives with one or more alternative objectives based on one or more of the plurality of tradeoffs for generating the one or more instantiated machine learning pipelines.

A determination component 460 may be determine a first instantiated machine learning pipeline is preferred compared to a second instantiated machine learning pipeline based on the plurality of tradeoffs and objectives.

The machine learning component 440, in association with the determination component 460 and the optimization component 470, may automatically select one or more machine learning pipelines from a ranked list of the one or more candidate, optimized machine learning pipeline based on the plurality of tradeoffs and objectives.

The machine learning component 440, in association with the determination component 460 and the optimization component 470, may collect feedback from the one or more candidate, optimized machine learning pipeline based on the plurality of tradeoffs and objectives to identify, adjust, and learn preferred objectives in relation to multiple tradeoffs. The learned data may be saved as historical data is and used in subsequent machine learning training.

In one aspect, the machine learning component 440 as described herein, may perform various machine learning operations using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, backpropagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting example of temporal difference learning may include Q-learning and learning automata. Specific details regarding any of the examples of supervised, unsupervised, temporal difference or other machine learning described in this paragraph are known and are within the scope of this disclosure. Also, when deploying one or more machine learning models, a computing device may be first tested in a controlled environment before being deployed in a public setting. Also even when deployed in a public environment (e.g., external to the controlled, testing environment), the computing devices may be monitored for compliance.

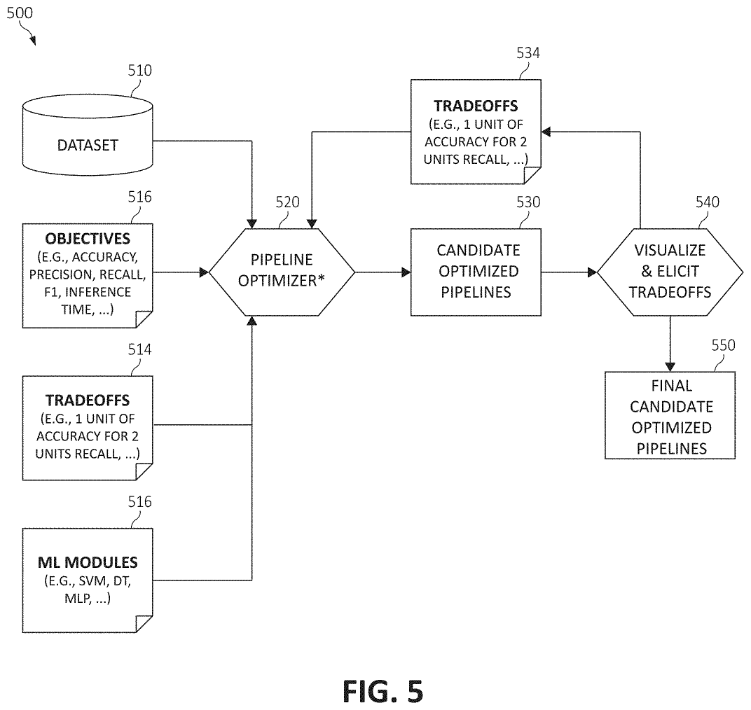

Turning now to FIG. 5, a block flow diagram depicts operations of a system 500 providing enhanced machine learning pipelines with multiple objectives and tradeoffs in a computing environment. In one aspect, one or more of the components, modules, services, applications, and/or functions described in FIGS. 1-4 may be used in FIG. 5. As shown, various blocks of functionality are depicted with arrows designating the blocks' of system 500 relationships with each other and to show process flow (e.g., steps or operations). Additionally, descriptive information is also seen relating each of the functional blocks' of system 500. As will be seen, many of the functional blocks may also be considered “modules” of functionality, in the same descriptive sense as has been previously described in FIGS. 1-4. With the foregoing in mind, the module blocks' of system 500 may also be incorporated into various hardware and software components of a system for automated evaluation of machine learning models in a computing environment in accordance with the present invention. Many of the functional blocks of system 500 may execute as background processes on various components, either in distributed computing components, or elsewhere.

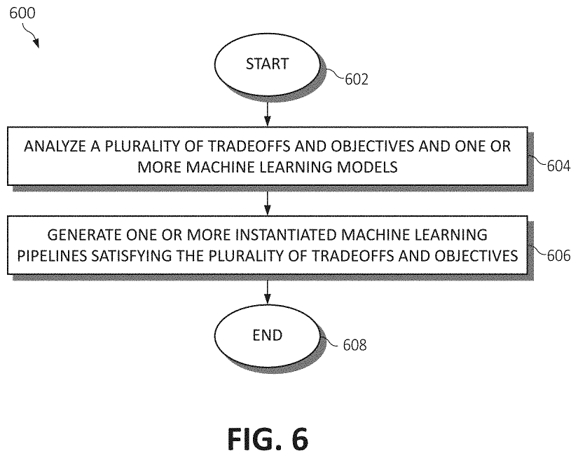

As depicted in FIG. 6, starting in block 520, a pipeline optimizer 520 (e.g., a joint machine learning optimizer that optimizes multiple objectives) may receive data from a dataset 510, one or more objectives 516 (e.g., accuracy, precision, recall, an F1score, inferences, time, etc.), one or more tradeoffs 514 (e.g., trade 1 unit of accuracy for 2 units of recall), and one or more machine learning (“ML”) modules 516 (e.g., support vector machine (“SVM”), decision tree (“DT”), multilayer perceptron (“MLP”), or other type of ML learning models or networks).

The pipeline optimizer 520 may process the received data and analyzing the tradeoffs 514, objectives 515, and one or more machine learning models from the ML modules 516. In some implementations, the pipeline optimizer 520 may process the dataset 510 (“D”) (and split and train the machine learning models with the dataset 510), objectives 516, tradeoffs 514, and the ML modules 516.

In some implementations the tradeoffs 514 are assigned a pair of vectors having a first vector representing a first objective and a second vector representing a second objective, where the first objective is a preferred objective compared to the second objective. That is, input tradeoffs 514 are pairs of vectors (u and ν, where u>ν), indicating that vector u is preferred to vector ν. For example, the vector pair (1,0) is greater than (0,2) (e.g., (1,0)>(0,2)) means that one unit of the first objective (e.g., vector u) is preferred to two units of the second objective (e.g., vector ν).

The tradeoffs and objectives may be processed by the pipeline optimizer 520 to generate one or more candidate, optimized pipelines 530 such as, for example, a set instantiated pipeline (“P”) of possibly optimal instantiated pipelines that satisfy one or more of the tradeoffs 514. That is, the pipeline optimizer 520 generates one or more instantiated machine learning pipelines 530 based on the plurality of tradeoffs and objectives. In some implementations, the instantiated machine learning pipelines 530 are a set of pipelines with each pipeline associated with a tuple u=(u₁, . . . , uₖ) representing the values of the k objectives, where k is a positive integer.

To further illustrate, consider the following operations for determining one or more optimal solutions (e.g., candidate optimized pipelines 530).

First, assume that P is an instantiated pipeline (i.e., a pipeline with a fixed selection of operations and corresponding hyper-parameters and is a pipeline that can be trained), Assume that vector u (e.g., u=(u₁, . . . , uₖ) be a corresponding utility vector representing the values of the k objectives that is determined on validation of dataset 510. One or more machine learning model objective/preferences (e.g., user preferences/objectives) over multiple objectives may be captured by weight vectors w=(w₁, . . . , wₖ) such that w₁ and wₖ add up to a 1 value (e.g., w₁+wₖ=1. However, these weights are unknown.

A set of tradeoffs (u,ν) where vector u is preferred to vector ν, together with a weight vector w define a preference relation over utility vector in R^{k}. §

A vector u is possibly optimal with respect to a set of vectors V if there exists a scenario where the weight vector w is w*u≥w*ν, for all vectors ν in the set of vectors V, where w*u is the component wise scalar product (gives a number). Also, it should be noted that u>_{w}v for a scenario of the weight vector w is u*w≥ν*w. (As used herein, “scenario” means a weight vector (w₁, w₂, . . . , wₖ). Therefore, you can read “if there exists a weight vector (wᵢ, w₂, . . . , wₖ)_{”.} Also, u>_{w}v denotes a dominance relation between vectors u and ν, namely vector u dominates vector ν relative to the weight vector (e.g., the scenario) w if *w≥ν*w holds (here u*w is the scalar product of two vectors).

For further explanation, the first step may be first define the dominance relation u>_{w}v between two vectors u and ν relative to a scenario or weight vector. Then, a vector u is possibly optimal with respect to a set of vectors V if there exists a scenario or weight vector such that f u>_{w}v holds for every vector ν in V.

For example, assume that an objective (“O”) is equal to the following: O={(3,24), (8,21), (9,19), (10,16), (11,14), (12,12), (13,8), (14,6)}. In this case, vectors {(10,16), (11,14), (13,8)} are not optimized, but vector (8,21) may be optimized (e.g., possibly optimal) because vector (8,21) is optimized in scenario (0.5, 0.5), with a weighted utility of (0.5*8+0.5*21)=14.5. That is, a vector is “possibly optimal” if there exists a scenario (e.g., weight vector) for which the vector dominates all other vectors. Also, vector (10,16) is not optimized since in every scenario vector (10,16) is worse than either vector (9,19) or vector (12,12). By “worse” the present disclosure means “dominated”. Namely, vector (10,16) is dominated by either (9, 19) or (12, 12). For example, scenario (weight vector)=(w₁=0.5, w₂=0.5). Then (w₁, w₂)*(10,16)=0.5*10+0.5*16=13. Similarly, (w₁, w₂)* (9,19)=0.5*9+0.5*19=14. Therefore, (10,16) is dominated by (9,19) relative to scenario (w₁=0.5, w₂,)*(=0.5).

It should be noted that weight vectors are not arbitrary values. Rather, to determine whether or not there exists a weight vector or not, one or more linear programs (LP) may be determined/calculated. To build such an LP (e.g., the objective function of the LP is just a constant in the present disclosure), if the LP is feasible, namely it has a solution, then that solution is actually the weight vector (e.g., scenario) that is desired. If the LP is not feasible, then there is no weight vector (scenario).

Specifically, vector (10,16)>_{w}(9,19) if 10*w₁+16*w₂≥9*w₁+19*w₂ (i.e., w₁₂≥3*w₂, which, since w₂=1−w₂ means w₂≥¾. Similarly, vector (10,16)≥_{w}((12,12) if 10*w₁+16*w₂≥12*w₁+12*w₂ which means that w₁≤⅔. Thus, in this scenario, there is no weight vector w that satisfies this condition. In regards to the condition, it is intended to show that there is no scenario (e.g., weight vector) for which (10,16) dominates (9, 19). Thus, a contradiction is reached or encountered where w₁≥¾ and w₁≤⅔, which is clearly not possible (w₁ cannot be greater than 0.75 and smaller than 0.67 at the same time).

However, suppose there is a tradeoff (1,0)>(0,1), which implies a unit of a first objective is more valuable than a unit of a second objective. This implies that w₁≥w₂ in all scenarios (consistent with the tradeoffs) and thus w₁≥0.5. Now, vector (3,24) is dominated by vector (8,21) since vector (3,24)>_{w}(8,21) only if 5 w₁≤3 w₂ and so (8,21)>_{w}(3,24) for all weight vector w consistent with the tradeoff . The possibly optimal vectors are PO(O)={(8,21), (9,19), (12,12), (14,6)}. The undominated vectors are UN(O)={(8,21), (9,19), (10,16), (11,14), (12,12), (13,8), (14,6)}. The undominated vectors are vectors that do not dominate each other. That is, it may be represented or defined that vector u dominates a vector ν (denoted by u>ν) if f for ui≥νi, for all i.

In one aspect, for checking, validating, and determining a condition of the PO pipeline (e.g., an optimal machine learning pipeline), assume there are a set of vectors V and another vector u. The pipeline optimizer 520 may output (e.g., generate) may determine if an optimal machine learning pipeline is optimized if vector u is in the function PO(V), namely vector u is potentially/possibly optimized (e.g., there exists a scenario w such that vector u dominates all the other vectors in the set of vectors V. Checking this condition can be done by checking and determining if a set of linear inequalities has a solution (e.g., as illustrated above with two vectors).

Also, assume for the linear program (“LP”)={}, for each vector ν in the set of vectors V, the LP may be added to the following inequality wᵢ*uᵢ+ . . . +wₖ*uₖ≥wᵢ*νᵢ+. . . +wₖ*νₖ. An equality (e.g., w₁+ . . . +wₖ=1) may be added to the LP. If the LP has a solution, there exists an instantiation of variables w₁, . . . , wₖ such that all constraints are satisfied. That is, the equality constrain is w₁+w₂+ . . . wₖ=1, and this constraint is used to ensure that the weights sum to 1.

At this point, the condition may be verified as “true” (e.g., vector u is possibly/potentially optimal/optimized) or the condition is verified as “false.” To obtain the condition, all ν that fail the vector ν may be eliminated from the set of vectors V in a PO(V) condition.

Returning now to block 530, the pipeline optimizer 520 may produces the one or more candidate, optimized pipelines 530, which may be a set P of possibly optimal instantiated pipelines that satisfy the tradeoffs. In some implementations, the pipeline optimizer 520 may fix or connect a pipeline structure to chain of n machine learning modules (e.g., M1-M2) and XM can be a set of variables corresponding to the machine learning modules (e.g., values=ML algorithms). Also, XH can be the variables corresponding to hyperparameters (e.g., values=hyperparameter values).

For simplicity, assume that all variables are discrete. Assume now that for function P={}, an in-depth search (can be randomized) can be executed over a space defined by the set of variables XM and the variables XH. A complete instantiation of a current algorithm selection xM of XM and the corresponding subset xMH (i.e., hyperparameter variables relevant to current algorithm selection xM) generates an instantiated pipeline Pᵢ.

The pipeline optimizer 520 may train the instantiated pipeline Pᵢ on the dataset 510 (e.g., training dataset “DT” and test or validation dataset “DV”) and compute its utility vector i.e., objective values u=(u₁, . . . , uₖ) on test dataset DV. The instantiated pipeline Pᵢ may be added to the set of pipelines P (together with its corresponding utility vector) and the condition P=PO(P) may be applied by removing all dominated pipelines (if any). In other words, by use of P=PO(P), it is intended to mean that the pipelines Pᵢ. are added to the set P. So, the set P looks like {P₁, P₂, . . . , Pₙ,}. PO(P) denotes a pruning operation, which basically removes from P all the pipelines that are not possibly optimal. To do that, the PO condition is checked/analyzed for each instantiated pipeline Pᵢ. relative to all other pipelines from P It should be noted that the PO condition is applied taking into account the tradeoffs.

In some implementations, the pipeline optimizer 520 may also visualize, provide, and generate/elicit the tradeoffs and the objectives, as in block 540. Also, at block 534, one or more tradeoffs may be analyzed, examined, and updated and used by the pipeline optimizer 520.

For example, for eliciting tradeoffs, consider the following. Assume there are a set of pipelines P={P₁, . . . Pₙ}, each associated with a utility vector uᵢ=(u₁, . . . , uₖ) with 1≤i≤n.

The pipeline optimizer 520 may generate, as output, a set of preferences (uⁱ>u^{j}). At this point, it may be assume that for preferences U={}, the tradeoff operations, as in block 534, may be repeated until a machine learning model and/or user is satisfied. For example, one or more machine learning pipelines P₁ and Pj may be selected from set of pipelines P such that Pi is preferred to Pj. If the set of preferences (uⁱ>u^{j}) is not in U={}, then the set of preferences (uⁱ>u^{j}) may be added to the preferences U, which are the allowed tradeoffs. A tradeoff is a preference between two vectors u and ν. Namely, it may be represented or defined that the that u>ν means that vectors u is preferred over vector ν. Then, U is the set of such pairs (u>ν). These tradeoffs are then used to generate constraints (e.g., inequality constraints) for the linear programs (“LP”) that are needed to solve to check the PO condition.

For example, a tradeoff (1,0)>(0,1) (e.g., informally, a unit of the first objective is more valuable than a unit of the second objective) and its corresponding constraint on the weights, means that w₁*1+w₂*0≥w₁*0+w₂*1, (i.e.,w₁≥w₂) and since w_1+w_2=1 it follows that w_1≥0.5. This means that the above tradeoff constrains w₁ to be greater or equal to 0.5. Thus, the optimal machine learning pipeline is optimized if vector u is in the function PO(V), namely vector u is potentially/possibly optimized (e.g., there exists a scenario w such that vector u dominates all the other vectors in the set of vectors V. Checking this condition can be done by checking and determining if a set of linear inequalities has a solution (e.g., as illustrated above with two vectors).

These elicited preferences U are used in a subsequent iteration to produce a new and smaller set of additional preferences P′ of possibly optimal pipelines.

As depicted in block 550, these final candidate, optimized pipelines may be recommended and generated. In some implementations, the final candidate, optimized pipelines are generated, instantiated machine learning pipelines based on the plurality of tradeoffs and objectives. The final candidate, optimized pipelines may be selected from a ranked order of the one or more candidate, optimized pipelines, at block 530.

The final candidate, optimized machine learning pipelines are a plurality of possibly optimal machine learning pipelines that include a set of possibly optimal instantiated machine learning pipelines that satisfy the tradeoffs. That is, the optimized machine learning pipelines are produced from a dataset 510, a plurality of objectives 514, set of pre-processors, transformers and estimators, a plurality of imprecise tradeoffs, from block 534, between one or more preferences/objective.

Turning now to FIG. 6, a method 600 for providing enhanced machine learning pipelines with multiple objectives and tradeoffs in a computing environment using a processor is depicted, in which various aspects of the illustrated embodiments may be implemented. The functionality 600 may be implemented as a method (e.g., a computer-implemented method) executed as instructions on a machine, where the instructions are included on at least one computer readable medium or one non-transitory machine-readable storage medium. The functionality 600 may start in block 602.

Tradeoffs, objectives, and one or more machine learning models may be analyzed, as in block 604. One or more instantiated machine learning pipelines are generated based on the tradeoffs and objectives, as in block 606. The functionality 600 may end, as in block 608.

In one aspect, in conjunction with and/or as part of at least one blocks of FIG. 6, the operations of method 600 may include each of the following. The operations of 600 may identify that a first instantiated machine learning pipeline is preferred compared to a second instantiated machine learning pipeline based on the plurality of tradeoffs and objectives.

The operations of 600 may generate a plurality of additional tradeoffs in relation to the objectives. The operations of 600 may define the objectives, the plurality of tradeoffs, and the one or more machine learning models, wherein an objective includes one or more performance objectives of the one or more machine learning models and a tradeoff includes one or more objectives that are replaced with one or more alternative objectives.

The operations of 600 may assign a tradeoff with a pair of vectors having a first vector representing a first objective and a second vector representing a second objective, wherein the first objective is a preferred objective compared to the second objective.

The operations of 600 may assign weighted values to each of the objectives. The operations of 600 may switch one or more of the objectives with one or more alternative objectives based on one or more of the plurality of tradeoffs for generating the one or more instantiated machine learning pipelines. The operations of 600 may determine a first instantiated machine learning pipeline is preferred compared to a second instantiated machine learning pipeline based on the plurality of tradeoffs and objectives.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

The descriptions of the embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for generating machine learning pipelines in a computing environment by one or more processors comprising:
analyzing a plurality of tradeoffs and objectives and one or more machine learning models; and
generate one or more instantiated machine learning pipelines based on the plurality of tradeoffs and objectives.

2. The method of claim 1, further including generating a plurality of additional tradeoffs in relation to the objectives.

3. The method of claim 1, further including defining the objectives, the plurality of tradeoffs, and the one or more machine learning models, wherein an objective includes one or more performance objectives of the one or more machine learning models and a tradeoff includes one or more objectives that are replaced with one or more alternative objectives.

4. The method of claim 1, further including assigning a tradeoff with a pair of vectors having a first vector representing a first objective and a second vector representing a second objective, wherein the first objective is a preferred objective compared to the second objective.

5. The method of claim 1, further including assigning weighted values to each of the objectives.

6. The method of claim 1, further including switching one or more of the objectives with one or more alternative objectives based on one or more of the plurality of tradeoffs for generating the one or more instantiated machine learning pipelines.

7. The method of claim 1, further including determining a first instantiated machine learning pipeline is preferred compared to a second instantiated machine learning pipeline based on the plurality of tradeoffs and objectives.

8. A system for generating machine learning pipelines in a computing environment, comprising:
one or more computers with executable instructions that when executed cause the system to:
analyzes a plurality of tradeoffs and objectives and one or more machine learning models; and
generates one or more instantiated machine learning pipelines based on the plurality of tradeoffs and objectives.

9. The system of claim 8, wherein the executable instructions when executed cause the system to generate a plurality of additional tradeoffs in relation to the objectives.

10. The system of claim 8, wherein the executable instructions when executed cause the system to define the objectives, the plurality of tradeoffs, and the one or more machine learning models, wherein an objective includes one or more performance objectives of the one or more machine learning models and a tradeoff includes one or more objectives that are replaced with one or more alternative objectives.

11. The system of claim 8, wherein the executable instructions when executed cause the system to assign a tradeoff with a pair of vectors having a first vector representing a first objective and a second vector representing a second objective, wherein the first objective is a preferred objective compared to the second objective.

12. The system of claim 8, wherein the executable instructions when executed cause the system to assign weighted values to each of the objectives.

13. The system of claim 8, wherein the executable instructions when executed cause the system to switch one or more of the objectives with one or more alternative objectives based on one or more of the plurality of tradeoffs for generating the one or more instantiated machine learning pipelines.

14. The system of claim 8, wherein the executable instructions when executed cause the system to determine a first instantiated machine learning pipeline is preferred compared to a second instantiated machine learning pipeline based on the plurality of tradeoffs and objectives.

15. A computer program product for generating machine learning pipelines in a computing environment, the computer program product comprising:
one or more computer readable storage media, and program instructions collectively stored on the one or more computer readable storage media, the program instruction comprising:
program instructions to incrementally allocate time series data from a time series data set for testing by one or more candidate machine learning pipelines based on seasonality or a degree of temporal dependence of the time series data;
program instructions to provide intermediate evaluation scores by each of the one or more candidate machine learning pipelines following each time series data allocation; and
program instructions to automatically select one or more machine learning pipelines from a ranked list of the one or more candidate machine learning pipelines based on a projected learning curve generated from the intermediate evaluation scores.

16. The computer program product of claim 15, further including program instructions to generate a plurality of additional tradeoffs in relation to the objectives.

17. The computer program product of claim 15, further including program instructions to define the objectives, the plurality of tradeoffs, and the one or more machine learning models, wherein an objective includes one or more performance objectives of the one or more machine learning models and a tradeoff includes one or more objectives that are replaced with one or more alternative objectives.

18. The computer program product of claim 15, further including program instructions to:
assign a tradeoff with a pair of vectors having a first vector representing a first objective and a second vector representing a second objective, wherein the first objective is a preferred objective compared to the second objective; and
assign weighted values to each of the objectives.

19. The computer program product of claim 15, further including program instructions to switch one or more of the objectives with one or more alternative objectives based on one or more of the plurality of tradeoffs for generating the one or more instantiated machine learning pipelines.

20. The computer program product of claim 15, further including program instructions to determine a first instantiated machine learning pipeline is preferred compared to a second instantiated machine learning pipeline based on the plurality of tradeoffs and objectives.
